(19) United States
(12) Patent Application Publication
(10) Pub. No.: US 2025/0307648 A1
(43) Pub. Date: Oct. 2, 2025

(54) KNOWLEDGE DISTILLATION FOR PRE-TRAINED LANGUAGE MODELS

(71) Applicant: Oracle International Corporation, Redwood Shores, CA (US)

(72) Inventors: Dai NGUYEN, Bisbane (AU); Mahinthan CHANDRAMOHAN, Brisbane (AU)

(73) Assignee: Oracle International Corporation, Redwood Shores, CA (US)

(21) Appl. No.: 18/622,784

(22) Filed: Mar. 29, 2024

(51) Int. Cl. G06N 3/096; G06N 3/045

(52) U.S. Cl. CPC G06N 3/096; G06N 3/045

(57) ABSTRACT

A method implements knowledge distillation for pre-trained language models. The method includes initializing a set of student layers of a student model from an initial set of teacher layers of a teacher model. The method further includes generating a distillation loss from the last student layer, the last teacher layer, a student prediction generated by the student model, and a teacher prediction generated by the teacher model. The method further includes generating a task loss from the student prediction. The method further includes training the student model with a training loss generated from combining the task loss and the distillation loss.

### BACKGROUND

Pre-trained language models (LMs) (e.g., CodeBERT, UniXcoder, etc.) may be used for text prediction and code representation learning. Pre-trained language models may yield improvements for programming language prediction and classification tasks (e.g., code clone detection bug localization, etc.). A challenge is to deploy pre-trained language models having large numbers of parameters (e.g., hundreds of millions of parameters) to devices with limited resources due to the high computational complexity and memory requirements for the models. A further challenge is to reduce the size of the models while maintaining accuracy.

### SUMMARY

In general, in one or more aspects, the disclosure relates to a method implementing knowledge distillation for pre-trained language models. The method includes initializing a set of student layers of a student model from an initial set of teacher layers of a teacher model. The method further includes generating a distillation loss from the last student layer, the last teacher layer, a student prediction generated by the student model, and a teacher prediction generated by the teacher model. The method further includes generating a task loss from the student prediction. The method further includes training the student model with a training loss generated from combining the task loss and the distillation loss.

In general, in one or more aspects, the disclosure relates to a system implementing knowledge distillation for pre-trained language models. The system includes at least one processor and an application executing on the at least one processor. The application performs operations that include initializing a set of student layers of a student model from an initial set of teacher layers of a teacher model. The application performs operations that further include generating a distillation loss from the last student layer, the last teacher layer, a student prediction generated by the student model, and a teacher prediction generated by the teacher model. The application performs operations that further include generating a task loss from the student prediction. The application performs operations that further include training the student model with a training loss generated from combining the task loss and the distillation loss.

In general, in one or more aspects, the disclosure relates to a non-transitory computer readable medium including instructions that may execute on a computer to perform operations. The instructions when executed perform operations that include initializing a set of student layers of a student model from an initial set of teacher layers of a teacher model. The instructions when executed perform operations that further include generating a distillation loss from the last student layer, the last teacher layer, a student prediction generated by the student model, and a teacher prediction generated by the teacher model. The instructions when executed perform operations that further include generating a task loss from the student prediction. The instructions when executed perform operations that further include training the student model with a training loss generated from combining the task loss and the distillation loss.

Other aspects of the one or more embodiments will be apparent from the following description and the appended claims.

### BRIEF DESCRIPTION OF DRAWINGS

FIG. 1 shows a computing system, in accordance with one or more embodiments of the disclosure.

FIG. 2A and FIG. 2B show methods in accordance with one or more embodiments of the disclosure.

FIG. 3 and FIG. 4 show examples in accordance with one or more embodiments of the disclosure.

FIG. 5A and FIG. 5B show a computing system and network environment, in accordance with one or more embodiments of the disclosure.

Like elements in the various figures are denoted by like reference numerals for consistency.

### DETAILED DESCRIPTION

Embodiments of the disclosure implement knowledge distillation for pre-trained machine learning models to reduce the size of machine learning models while maintaining accuracy and deploy devices with limited processing and memory resources. A machine learning model referred to as a student model is generated from a machine learning model referred to as a teacher model, which may be pre-trained. The teacher model has multiple layers. An initial set of the layers of the teacher model may be copied to the student model. Knowledge distillation is performed using multiple loss functions to generate a distillation loss. The distillation loss is combined with a task loss to generate a training loss. The training loss is used to update the parameters of the student model. The training model and the student model may be language models, which may be used for text prediction, code representation learning, etc.

Knowledge distillation may be used to train a lightweight student model from a pre-trained teacher model. Distillation trains the student model to imitate the behavior of the teacher model so that the student model obtains accuracy performance competitive with the teacher model while reducing the latency for devices with limited computing resources. Devices with limited computing resources may include smartphones, desktop computers, laptops, etc. as compared to server computers. The limit may be in the amount of random access memory (RAM) or processing power available. In many cases, the computing requirements of the teacher model is cost or performance prohibitive on devices with limited resources to satisfy response time constraints for applications. By generating a student model that may execute on devices with limited resources, such devices are able to have the accuracy similar to that of the teacher model while satisfying the timing constraints, which may not be possible with the teacher model. Thus, such devices may use the additional functionality provided by the student model with accuracy similar to the teacher model without the latency of the teacher model.

Embodiments of the disclosure perform knowledge distillation to learn the lightweight student model from the pre-trained teacher model using student initialization, distillation mapping, and knowledge transfer. These techniques are combined into a unified framework for knowledge distillation to generate student models from teacher models that may obtain comparable performance when using fewer parameters and running faster on equivalent central processing units (CPUs). For example, a student model may use 50% fewer parameters and run four times faster than a teacher model on an equivalent computing system.

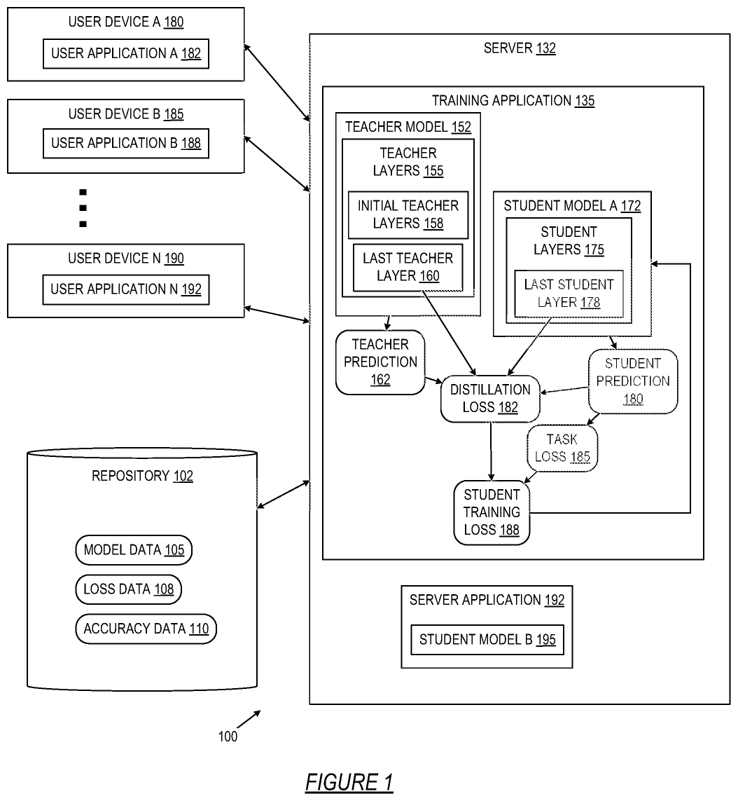

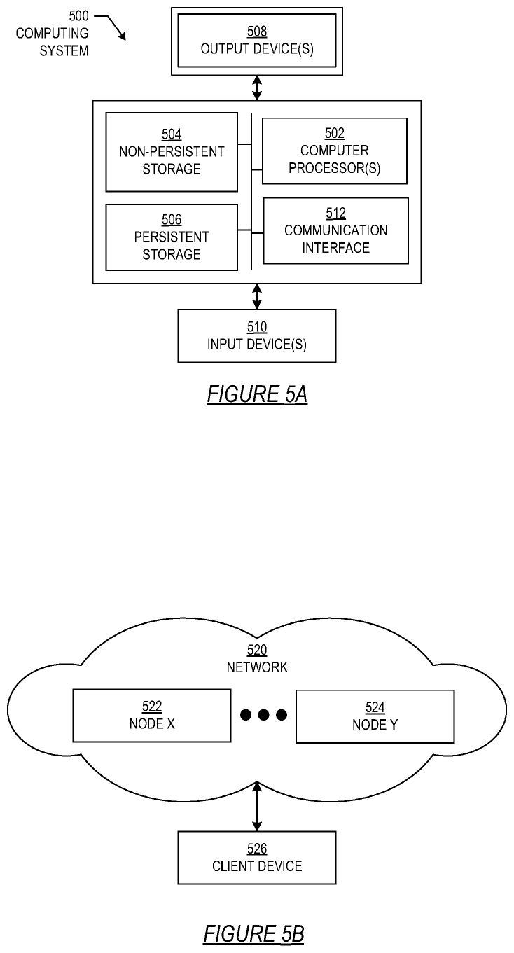

Turning to FIG. 1, the system (100) is a computing system shown in accordance with one or more embodiments. The system (100) and corresponding components may utilize the computing systems described in FIG. 5A and FIG. 5B to perform knowledge distillation for pre-trained machine learning models. Different architectures may be used. The system (100) includes the repository (102), the server (132), the user devices A (180) and B (185) through N (190).

The repository (102) is a type of storage unit and/or device (e.g., a file system, database, data structure, or any other storage mechanism) for storing data. The repository (102) may include multiple different, potentially heterogeneous, storage units and/or devices. The repository (102) stores data utilized by other components of the system (100). The data stored by the repository (102) includes the model data (105), the loss data (108), and the accuracy data (110).

The model data (105) is data for the models used or trained by the system. The model data (105) may include the source code and the executable code for the models as well as the training data used to train the models. The source code and the executable code may include the parameters of the models. The parameters may include the weights, matrices, etc., used by the models to process inputs and generate outputs.

The loss data (108) is data that quantifies the loss (which may also be referred to as the error) of the outputs of the models trained by the system. The loss data (108) may be for multiple models and include distillation loss, task loss, training loss, etc.

Distillation loss is a loss that is generated to distill knowledge from one model (e.g., the teacher model (152)) to another model (e.g., the student model A (172)). A sum or weighted combination of multiple different losses may be used to form a distillation loss. For example, the distillation loss (182) may be formed from hidden parameter loss, hidden state loss, prediction loss, etc.

Hidden parameter loss is the difference between the sets of parameters of different models. For example, the hidden parameter loss between the teacher model (152) and the student model A (172) may be the difference between the parameters of the last teacher layer (160) of the teacher model (152) and the parameters of the last student layer (178) of the student model A (172).

Hidden state loss is the difference between the hidden states of different models. For example, the hidden state loss between the teacher model (152) and the student model A (172) may be the difference between the hidden state of the last teacher layer (160) and the hidden state of the last student layer (178). The hidden state of a layer may be the raw output from the layer.

Prediction loss is the difference between the predictions of different models. For example, the prediction loss may be the difference between the teacher prediction (162) and the student prediction (180).

Task loss is the difference between the output of a model and the expected output of the model. For example, the task loss (185) is the difference between the student prediction (180) and the expected output of the student model A (172).

Training loss is the loss calculated during training that is used to update the parameters of a model. For example, the training loss (188) is a combination of the distillation loss (182) and the task loss (185) and is used to update the parameters of the student model A (172).

The accuracy data (110) is data that quantifies the accuracy of the models of the system (100). For example, accuracy data (110) may include accuracies for the teacher model (152) and the student models A (172) and B (195). The accuracy for the student model A (172) during training may be less than the accuracy for the student model B (195), which is deployed. The accuracy of the student model B (195) may approach, including being equal to, the accuracy of the teacher model (152).

Continuing with FIG. 1, the system (100) also may include the server (132). The server (132) is one or more computing systems, possibly in a distributed computing environment. An example of the server (132) may be the computing system shown in FIG. 5A.

The server (132) may host and/or execute one or more processes, software, applications, etc. For example, the server (132) may execute the training application (135) and the server application (192). The server (132) may interact with the user devices A (180) and B (185) through N (190) to train and use machine learning models, including the teacher model (152) and the student models A (172) and B (195).

The training application (135) includes a set of programs used to train machine learning models by the system (100). In an embodiment, the training application (135) generates the student model A (172) from the teacher model (152) and operates the teacher model (152) in conjunction with the student model A (172) to distill knowledge from the teacher model (152) to the student model A (172). The training application (135) trains the student model A (172) by generating the distillation loss (182), the task loss (185), and the training loss (188) from the teacher model (152) and the student model A (172) and using the training loss (188) to update the parameters of the student layers (175) of the student model A (172).

The teacher model (152) is a machine learning model that generates the teacher prediction (162) from an input. In an embodiment, the teacher model (152) is a pre-trained language model that may be fine tuned for programming language tasks. In an embodiment, the input to the teacher model (152) is a string of character data that may include language constructs such as words, characters, symbols, phrases, etc. of natural language or programming language. The string is processed by the teacher model (152) to generate the teacher prediction (162). To process the string, a tokenizer may extract tokens from the string. The tokens may be converted to vectors that are processed by the teacher layers (155).

The teacher layers (155) are the layers of the teacher model (152) that process inputs to generate the outputs of the teacher model (152). The input received by a layer is processed using the parameters of the layer to generate the output for the layer, which may be used as an input for the next layer. The teacher layers (155) may include input layers, hidden layers, and output layers.

In an embodiment, the input layers of the teacher layers (155) may include one or more embedding layers that convert the tokens extracted from the string to embedding vectors. The embedding vectors may represent the semantic meaning of the language constructs identified by the tokens. An embedding vector may be represented by an ordered tuple of real numbers (x₁, x₂, . . . , xₙ), where each number represents a component along a specific axis or dimension. The space of the embedding vectors is a semantic space in which embedding vectors with similar locations (i.e., values) in the embedding vector space have similar meaning in natural language or programming language.

After the input layers, the teacher layers (155) may include several hidden layers that further process the vectors output by the input layers. For example, the hidden layers may include convolutional layers of a convolutional neural network (CNN), recurrent layers of a recurrent neural network (RNN), transformer layers of a transformer network using attention, etc.

The teacher layers (155) may also include one or more output layers after the hidden layers to convert the output from the hidden layers to the output for the teacher model (152). The output layers may include one or more fully connected (also referred to as linear) neural networks that generate a set of output vectors. The output vectors may be converted back to tokens, which are then converted into an output string.

The initial teacher layers (158) are a subset of the teacher layers (155) that are used to form the student layers (175) of the student model A (172). In an embodiment, the initial teacher layers (158) may include the input layers and a number (“k”) of the hidden layers from the teacher layers (155).

As an example, the teacher layers (155) may include an embedding layer, 12 hidden layers, and an output layer. The initial teacher layers (158) may include the embedding layer and the first 3 (e.g., “k=3”) hidden layers of the teacher layers (155).

The last teacher layer (160) is the last hidden layer of the teacher layers (155). In an embodiment, the last teacher layer (160) is not one of the initial teacher layers (158). Stated another way, the last teacher layer (160) is excluded from the initial teacher layers (158). Thus, the last teacher layer (160) and the initial teacher layers (158) are disjoint. For example, the teacher layers (155) may include 12 hidden layers, the initial teacher layers (158) may include the first 3 of the 12 hidden layers, and the last teacher layer (160) may be the last layer or layer 12 of the hidden layers. The last teacher layer (160) is used in conjunction with the last student layer (178) of the student model A (172) to generate the distillation loss (182).

The teacher prediction (162) is an output of the teacher model (152). In an embodiment, the teacher prediction (162) may be a sequence of vectors that are within the embedding vector space and may be mapped to a set of tokens from which an output string may be generated that is responsive to an input string to the teacher model (152).

The student model A (172) is a machine learning model generated from the teacher model (152) that generates the student prediction (180) from an input. The student model A (172) may have fewer layers than the teacher model (152) to reduce the amount of processing power and memory used to generate the student prediction (180) from the student model A (172) than used to generate the teacher prediction (162) from the teacher model (152). The student model A (172) is the student model as the model is being trained and the student model B (195) is the trained version of the student model that is deployed. The student model A (172) includes the student layers (175).

The student layers (175) are the layers of the student model A (172) that process an input to generate the output. In an embodiment, the student layers (175) are initialized as a copy of the initial teacher layers (158). The student layers (175) include the last student layer (178).

The last student layer (178) is one of the last layers of the student model A (172). In an embodiment, the last student layer (178) may be the last hidden layer within the student layers (175). For example, the student layers (175) may include the first 3 hidden layers from the 12 hidden layers of the teacher layers (155) with the last student layer (178) being the last or third layer of the 3 hidden layers copied from the initial teacher layers (158).

The student prediction (180) is an output of the student model A (172). The student prediction (180) may be structured the same as the teacher prediction (162) but may have a different value since it was generated with the student model A (172) instead of with the teacher model (152).

The distillation loss (182) is the loss between aspects of the teacher model (152), the student model A (172), and their respective outputs. The distillation loss (182) is generated to distill knowledge from the teacher model (152) to the student model A (172).

The task loss (185) is the loss between the output of the student model A (172) and an expected output. For example, the task loss (185) may be the difference between the student prediction (180) and the expected output for a given input.

The training loss (188) is the loss generated for one input sample. The training loss (188) is a combination of the distillation loss (182) and the task loss (185). In an embodiment, the combination may be weighted to favor the distillation loss (182) for knowledge transfer or to favor the task loss (185) for task completion accuracy. For example, the distillation loss (182) may be weighted at 0.6 (i.e., greater than 0.5) with the task loss (185) weighted at 0.4 to favor knowledge transfer from the teacher model (152) to the student model A (172).

The server application (192) includes a set of programs to use the student model B (195). The server application (192) may respond to requests from the user devices A (180) and B (185) through N (190) for output generated by the student model B (195). For example, a request may include a string to be used as an input to the student model B (195). The server application (192) may input the string to the student model B (195) and transmit the output from the student model B (195) back to the sender of the request.

The student model B (195) is a trained version of the student model A (172). The student model B (195) is deployed through the server application (192) to generate responses to requests from the user devices A (180) and B (185) through N (190).

Continuing with FIG. 1, the user devices A (180) and B (185) through N (190) may interact with the server (132). The user devices A (180) and B (185) through N (190) may be computing systems in accordance with FIG. 5A and FIG. 5B. The user devices A (180) and B (185) through N (190) may include and execute the user applications A (182) and B (188) through N (192).

The user applications A (182) and B (188) through N (192) are programs running on the user devices A (180) and B (185) through N (190). The user applications A (182) and B (188) through N (192) present user interfaces to display information and receive inputs from users to interact with the system (100).

The user devices A (180) and B (185) through N (190) operate in conjunction with the server (132) to train and use machine learning models. For example, the user device N (190) may be operated by an administrator to generate and train the student model A (172) that may be deployed as the student model B (195).

The user device A (180) may be operated by a user to interact with the student model B (195) after deployment. For example, the user device A (180) may receive a string from a user that is sent in a request to the server (132). The server application (192) processes the string from the request to generate a response that is sent back to the user device A (180), which may display the response.

Although described within the context of a client server environment with servers and user devices, aspects of the disclosure may be practiced with a single computing system and application. For example, a monolithic application may operate on a computing system to perform the same functions as the components of the system (100).

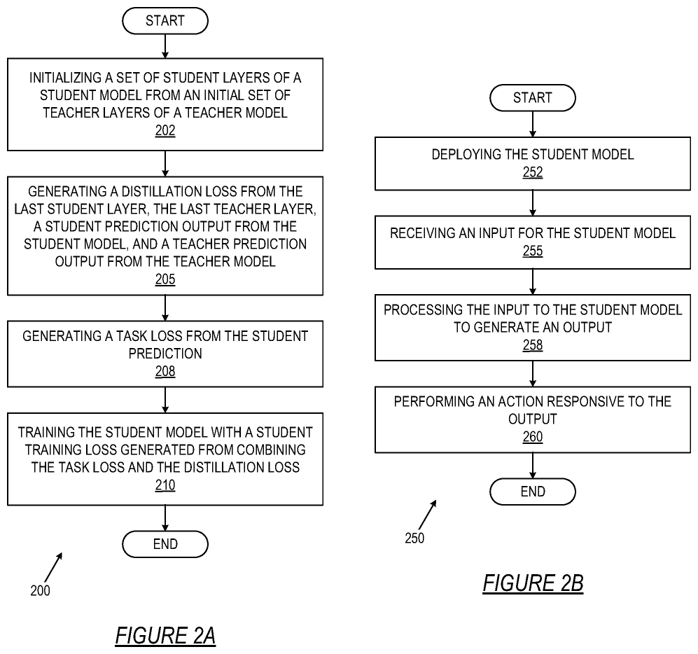

Turning to FIG. 2, the process (200) performs knowledge distillation for pre-trained language models. The process (200) may be performed using components from the system (100) of FIG. 1.

Step 202 of the process (200) includes initializing a set of student layers of a student model from an initial set of teacher layers of a teacher model. As an example, the set of student layers may be initialized by copying an initial set of teacher layers from the teacher model. The initial set of layers may include an input layer and one or more hidden layers that process subsequent to the input layer. For example, the layers that are copied may include an embedding layer that forms the input layer and a set of transformer layers (or convolutional layers, etc.) that form the hidden layers.

The student model may include a last student layer as one of the set of student layers. The teacher model may include a set of teacher layers that include the initial set of teacher layers and a last teacher layer that is not part of the initial set of teacher layers. In an embodiment, the last layer of the set of initial teacher layers forms the last student layer of the student. Notably, the last layer of the set of initial teacher layers is different from the last teacher layer of the teacher model. Thus, when copied, the last student layer is different from the last teacher layer in an embodiment. For example, the teacher model may include 12transformer layers with the twelfth transformer layer being the last teacher layer of the teacher model. The initial three transformer layers (e.g., the first, second, and third transformer layers) from the teacher model may be copied to form the student layers of the student model. The last student layer of the student model would be the third transformer layer from the 12 transformer layers copied from the teacher model.

Step 205 of the process (200) includes generating a distillation loss from the last student layer, the last teacher layer, a student prediction generated by the student model, and a teacher prediction generated by the teacher model. The distillation loss may be generated using a processor to combine multiple loss values, including hidden parameter loss, hidden state loss, prediction loss, etc., which may be generated using the last student layer, the last teacher layer, the student prediction, and a teacher prediction. In an embodiment, the distillation loss ( [symbol] _{distill}) may be generated using Equation (1) below:

$${ℒ}_{distill} = {ℒ}_{pred} + {ℒ}_{hid} + {ℒ}_{att} \qquad ( 1 )$$

wherein [symbol] _{pred} denotes a prediction loss, [symbol] _{hid} denotes a hidden state loss, and [symbol] ₐₜₜ denotes a hidden parameter loss.

In an embodiment, the prediction loss is generated from the teacher prediction and the student prediction. The prediction loss ( [symbol] _{pred}) may be generated using Equation (2) below:

$${ℒ}_{pred} = MSE ( {z}^{T} , {z}^{S} ) \qquad ( 2 )$$

wherein z^{T} and z^{S} denote logits (i.e., outputs) from the teacher and student models, respectively. The mean squared error may be calculated by taking the squared difference between each corresponding pair of values from the teacher output vector and the student output vector, summing up the square of differences, and then dividing by the number of elements in the vectors. The result is a single scalar value that quantifies the prediction loss as the average squared difference between the vectors.

In an embodiment, the hidden state loss is generated from a hidden teacher state from the last teacher layer and a hidden student state from the last student layer. For example, the hidden state loss ( [symbol] _{hid}) may be generated using Equation (3) below:

$${ℒ}_{hid} = MSE ( {H}^{T} , {H}^{S} ) \qquad ( 3 )$$

wherein H^{T}∈ [symbol] and H^{S}∈ [symbol] denote the hidden states of the last teacher and last student layers, respectively, d is the hidden size, and l is the input sequence length. The mean squared error between the hidden states of the last layer of a student model and the last layer of a teacher model may be generated by obtaining the hidden states from both models for a given set of inputs, compute the squared differences between the corresponding elements of the hidden states, and calculate the mean of these squared differences to obtain the hidden state loss as the mean squared error, which provides a measure of the average squared discrepancy between the hidden states of the last layers of the student and teacher models. The hidden state loss may be used as a form of transfer learning to transfer knowledge from the teacher model to the student model.

In an embodiment, the hidden parameter loss is generated from a set of teacher parameters from the last teacher layer and a set of student parameters from the last student layer. For example, when the parameters are the values of attention matrices of transformer layers that each have multiple attention heads, the hidden parameter loss ( [symbol] ₐₜₜ) may be generated using Equation (4) below:

$${ℒ}_{att} = \frac{1}{h} {\sum }_{i = 1}^{h} MSE ( {A}_{i}^{T} , {A}_{i}^{s} ) \qquad ( 4 )$$

wherein Aᵢ^{T}∈ [symbol] and Aᵢ^{S}∈ [symbol] denote attention matrices of the i-th head of the last teacher layer and the last student layer of the teacher model and the student model, respectively, with h representing the number of heads of attention in the layer. In other words, the hidden parameter loss between transformer layers that form the last layers of teacher and student models is calculated as the average of the mean squared errors for the attention heads of the last layers of the teacher and student models.

Step 208 of the process (200) includes generating a task loss from the student prediction. In one embodiment, the task loss is generated using a processor to combine the student prediction with an expected value.

Generating a task loss from a student prediction model involves comparing the outputs from the student prediction model to the expected values for a given input. The process begins by calculating a student prediction (which is an output of the student prediction model) for an input. The error between the student prediction and the expected value is quantified using a loss function, which assigns a numerical value to the error.

Various types of loss functions may be used that each serve distinct purposes in machine learning tasks. Mean squared error (MSE) may be used for regression problems, measuring the average squared difference between predicted and actual values. Cross-entropy loss, e.g., binary cross-entropy for two-class problems and categorical cross-entropy for multi-class tasks, evaluates the dissimilarity between predicted probability distributions and true class labels, emphasizing correct class assignment. Hinge loss may be used with support vector machines and binary classification, encouraging correct classification by penalizing misclassifications. Huber loss combines aspects of mean squared error and absolute error, offering a compromise that is less sensitive to outliers in regression scenarios.

Step 210 of the process (200) includes training the student model with a training loss generated from combining the task loss and the distillation loss. In an embodiment, the training loss is generated using a processor to perform a weighted combination of the task loss with the distillation loss. The training loss ( [symbol] ) may be generated using Equation (5) below:

$$ℒ = ( 1 - α ) {ℒ}_{task} + α {ℒ}_{distill} \qquad ( 5 )$$

wherein [symbol] ₜₐₛₖ denotes the task loss and [symbol] _{distill} denotes the distillation loss. The task loss and the distillation loss are combined with the weight α, which is in the range of 0 to 1. Larger values of α increase the weight of the distillation loss to increase the amount of transfer learning. Lower values of α increase the weight of the task loss to focus on the task being learned instead of transferring knowledge.

In an embodiment, the student model is trained using a processor to backpropagate the training loss to one or more student layers of the student model. Training the student model through backpropagation involves iteratively updating the parameters of the student model based on the training loss to minimize the discrepancy between the predictions from the student model and the expected output for a given input. The training loss is backpropagated through the layers of the student model, updating the parameters of the layers of the student model using an optimization algorithm, e.g., stochastic gradient descent. The iterative process of calculating the training loss and backpropagating updates to the parameters of the student model using the training loss may be repeated for multiple training samples across multiple epochs until the model achieves satisfactory performance. Backpropagation of the training loss guides the adjustments made to the student layers, enabling the model to learn and improve its predictive capabilities based on the task loss (the error between the prediction output and the expected output) and the distillation loss (the difference between aspects of the teacher model and the student model as a form of knowledge transfer). The layers of the student model that may be updated during training may include layers of the set of student layers, input layers, output layers, etc.

Turning to FIG. 2B, the process (250) deploys machine learning models. The process (250) may be performed using components from the system (100) of FIG. 1.

Step 252 of the process (250) includes deploying the student model. Deploying the student model involves a series of steps to transition the student model from a development environment to a production environment where the student model may be used to make real-time predictions. The student model is prepared for deployment by packaging the student model. Once packaged, the student model is integrated into a production system, and infrastructure is set up to handle incoming data. The infrastructure may include adjusting application programming interfaces (APIs) to use the student model. Testing and validation may then be performed to ensure the student model operates as expected in the production environment. Monitoring and maintenance mechanisms may be established to track the performance of the student model over time, allowing for updates or adjustments as needed to ensure continued accuracy and relevance of the deployed student model.

Step 255 of the process (250) includes receiving an input for the student model. Receiving the input may include collecting raw data or features, which may include strings provided by users. The input may be preprocessed to ensure the input aligns with the inputs expected by the student model. Preprocessing may include cleaning, normalization, and transformation of the input.

Step 258 of the process (250) includes processing the input to the student model to generate an output. Generating the output involves applying a layer of the student model to the input to generate an output and then applying a subsequent layer to the output to generate a subsequent output until all the layers have been applied to the original input and form the output of the student model.

Step 260 of the process (250) includes performing an action responsive to the output. The action may be performed automatically. For example, the student model may be provided a prompt to identify an error in a software program. In response to the output identifying an error and rewriting the software program, as computing system recompile and deploy the rewritten software program.

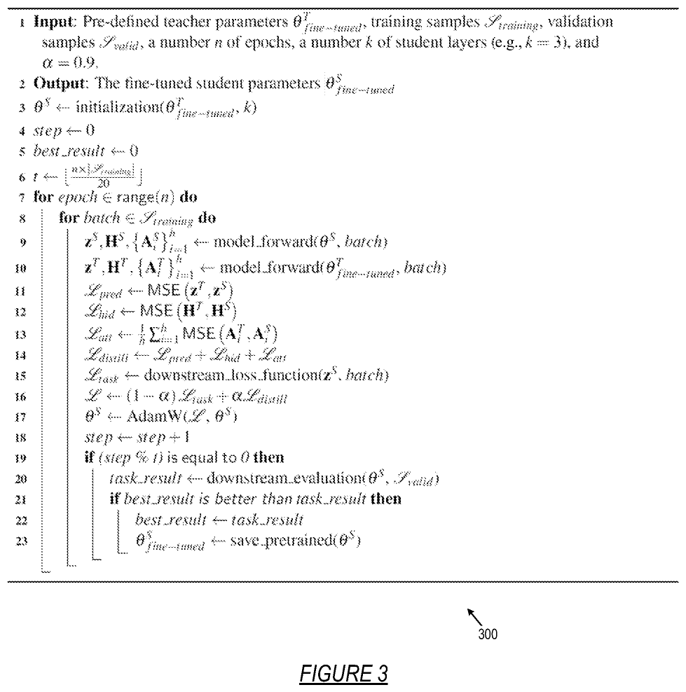

Turning to FIG. 3, the pseudo code (300) implements an algorithm of knowledge distillation for pre-trained language models.

At line 1, the inputs may be set. The inputs may include the teacher parameters θ_{fine-tuned}^{T}, training samples [symbol] _{training}, validation samples [symbol] _{valid}, a number of n epochs, a number k of student layers (e.g., k=3), and weight α=0.9. The teacher parameters θ_{fine-tuned}^{T} are the parameters of the teacher model, which may be after fine tuning of the teacher model. The training samples [symbol] _{training} are the input data used to train the student model with knowledge distillation from the teacher model. The validation samples [symbol] _{valid}, are the input data used to validate the student model after being trained with the training samples. The number n of epochs is hyperparameter that identifies the number of times the learning algorithm will work through the training dataset (e.g., the training samples [symbol] _{training}). The number k of student layers is the number of student layers copied to the student model from the teacher model. The weight α is weight used to combine the distillation and task losses into the training loss during training.

At line 2, the outputs are identified as the fine-tuned student parameters θ_{fine-tuned}^{S} The fine-tuned student parameters are the parameters of the student model after training.

At line 3, the student model parameters θ^{S} are initialized. The student model parameters θ^{S} are initialized to the first k layers of the teacher model.

At line 4, the current training step is initialized. The current training step is initialized to 0.

At line 5, the best result is initialized. The best result is initialized to 0.

At line 6, the number t of training steps to perform before checking the current student model being trained against the current best version of the student model is initialized. The number t of training steps is initialized to the number n of epochs times the number of training samples [symbol] _{training} divided by 20. Different values may be used.

At line 7, a for loop is initialized. The for loop performs a number of iterations equal to the number n of epochs.

At line 8, a nested for loop is initialized. The nested for loop performs an iteration for each sample in the training samples [symbol] _{training}.

At line 9, a forward pass of the student model being trained is performed. The forward pass updates the output of the student model (z^{S}), the hidden state of the last student layer (H^{S}), and the parameters of each of the attention heads of the last student layer ({Aᵢ^{S}}ᵢ₌₁^{h}).

At line 10, a forward pass of the teacher model from which knowledge is being distilled is performed. The forward pass updates the output of the teacher model (z^{T}), the hidden state of the last teacher layer (H^{S}), and the parameters of each of the attention heads of the last teacher layer ({Aᵢ^{T}}ᵢ₌₁^{h}).

At line 11, the prediction loss ( [symbol] _{pred}) is calculated. The prediction loss ( [symbol] _{pred}) is the mean squared error between the outputs of the teacher and student models (z_{T} and z_{S}).

At line 12, the hidden state loss ( [symbol] _{hid}) is calculated. The hidden state loss ( [symbol] _{hid}) is the mean squared error between the hidden states of the last layers of the teacher and student models (H^{T} and H^{S}).

At line 13, the hidden parameter loss ( [symbol] ₐₜₜ) is calculated. The hidden parameter loss ( [symbol] ₐₜₜ) is the average of the mean squared errors of the attention heads of the last layers of the teacher and student models (Aᵢ^{T} and Aᵢ^{S}).

At line 14, the distillation loss ( [symbol] _{distill}) is calculated. The distillation loss ( [symbol] _{distill}) is calculated as the sum of the prediction loss ( [symbol] _{pred}), the hidden state loss ( [symbol] _{hid}), and the hidden parameter loss ( [symbol] ₐₜₜ).

At line 15, the task loss ( [symbol] ₜₐₛₖ) is calculated. The task loss ( [symbol] ₜₐₛₖ) is calculated by applying a downstream loss function to the student predictions (outputs (z^{S}) from the student model) for a batch of samples from the training samples ( [symbol] _{training}).

At line 16, the training loss ( [symbol] ) is calculated. The training loss ( [symbol] ) is calculated by applying 1 minus the weight (α) to the task loss ( [symbol] ₜₐₛₖ) and applying the weight (α) to the distillation loss ( [symbol] _{distill}) and summing the results.

At line 17, the student model parameters θ^{S} are updated. The student model parameters θ^{S} are updated by applying the optimization function (“AdamW”) to the training loss ( [symbol] ) and the student model parameters (θ^{S}) (prior to the update).

At line 18, the number of steps performed is adjusted. The number of steps is increased by 1.

At line 19, a determination is made as to whether the number of steps is a multiple of the number t. If so, then lines 20 to 23 may be performed.

At line 20, validation testing is performed. The validation testing is performed by applying the student model with the student model parameters (θ^{S}) to the validation samples ( [symbol] _{valid}) to determine the task result. The task result is a scalar value that may identify the accuracy of the student model being trained on the validation samples. The accuracy of the model may be a value in the range for 0 to 1 representing 0 to 100% accuracy.

At line 21, a determination is made the best result (originally initialized to zero) is better than the task result generated at line 20. If so, lines 22 to 23 may be performed.

At line 22, the best result is updated. The best result is updated with the task result when it is determined at line 21 that the task result is better than the best result.

At line 23, the fine-tuned student parameters (θ_{fine-tuned}^{S}) of the student model is updated. The fine-tuned student parameters (θ_{fine-tuned}^{S}) are updated with the student parameters (θ^{S}) of the student model being trained.

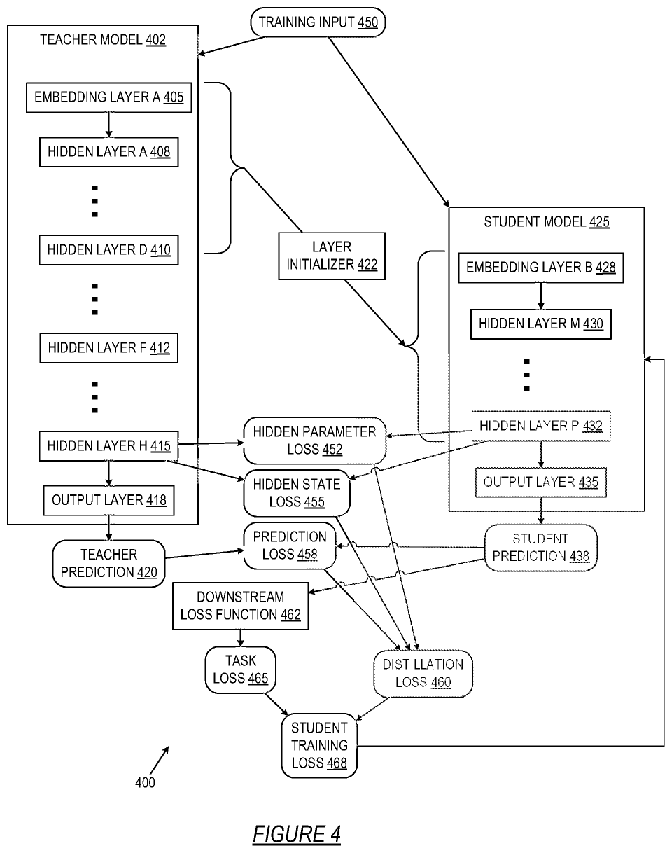

Turning to FIG. 4, the data flow (400) performs knowledge distillation for pre-trained language models. The teacher model (402) includes the embedding layer A (405), the hidden layers A (408) through H (415), and the output layer (418). The embedding layer A (405) may include multiple layers to convert string data to tokens and the tokens to vectors that represent words from the string data in a semantic vector space. The hidden layers A (408) through H (415) include the hidden layers D (410) and F (412). The hidden layers A (408) through D (410) may be the layers copied to the student model (425). The hidden layers after the hidden layer D (410) (which include the hidden layers F (412) through H (415)) may not be copied to the student model (425). The hidden layer H (415) is the last hidden layer of the teacher model (402).

The layer initializer (422) is a component that initializes the student model (425) from the teacher model (402). In an embodiment, layer initializer (422) copies the embedding layer A (405) and the hidden layers A (408) through D (410) from the teacher model (402) to the student model (425). The embedding layer A (405) and the hidden layers A (408) through D (410) copied from the teacher model (402) become the embedded layer B (428) and the hidden layers M (430) through P (432) of the student model (425). The hidden layer P (432) is the last hidden layer of the student model (425).

During the training of the student model (425), the training input (450) is processed by both the teacher model (402) and the student model (425). The layers of the teacher model (402) and the student model (425) operate by applying a current layer to the output of a previous layer to generate the output of the current layer, which is used as the input for the subsequent layer. For example, the output layer (418) of the teacher model (402) is applied to the outputs of the hidden layer H (415) to generate the teacher prediction (420) generated in response to the training input (450). Similarly, the output layer (435) of the student model (425) is applied to the outputs of the hidden layer P (432) to generate the student prediction (438) that is also generated in response to the training input (450).

The hidden parameter loss (452) is generated from the last hidden layers H (415) and P (432) of the teacher model (402) and the student model (425), respectively. In an embodiment, the hidden parameter loss (452) is the average mean squared error between the attention heads of the hidden layers H (415) and P (432).

The hidden state loss (455) is generated from the outputs of the last hidden layers H (415) and P (432) of the teacher model (402) and the student model (425), respectively. The outputs from the last hidden layers H (415) and P (432) may be captured before being input to the output layers (418) and (435) of the teacher model (402) and the student model (425), respectively. In an embodiment, the hidden state loss (455) is the mean squared error between the outputs of the last hidden layers H (415) and P (432).

The prediction loss (458) is generated from the teacher prediction (420) and the student prediction (438) of the teacher model (402) and the student model (425), respectively. In an embodiment, the prediction loss (458) is the mean squared error between the teacher prediction (420) and the student prediction (438).

The distillation loss (460) is a combination of the hidden parameter loss (452), the hidden state loss (455), and the prediction loss (458). In an embodiment, the distillation loss (460) may be an unweighted sum of the hidden parameter loss (452), the hidden state loss (455), and the prediction loss (458).

The downstream loss function (462) is a component that generates the task loss (465) from the student prediction (438). The task loss (465) quantifies the error between the output of the student model (425) (i.e., the student prediction (438)) and the output expected to be generated based on the training input (450).

The training loss (468) is a combination of the task loss (465) and the distillation loss (460). In an embodiment, the training loss (468) is a weighted combination of the task loss (465) and the distillation loss (460). The training loss (468) is fed back into the student model (425) using back propagation to update the parameters of the layers of the student model (425).

In an embodiment, the student model (425) may be used as a language model for programming language or natural language. For example, the student model (425) may be prompted with “write a hello world program in python”. In response, the student model may output “print (‘Hello, World’)”, which is a python program to print “Hello, World!”. Where the teacher model (402) may operate on a server, the student model (425) may operate on a laptop, desktop, smartphone, etc.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage device(s) (504), persistent storage device(s) (506), a communication interface (512) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (508). The inputs may include text input, audio input, video input, etc., which may be processed and transmitted by the computing system (500) in accordance with the disclosure. The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (508) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (508) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform all or a portion of one or more embodiments.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising
initializing a set of student layers of a student model from an initial set of teacher layers of a teacher model,
wherein the student model comprises a last student layer as one of the set of student layers, and
wherein the teacher model comprises a set of teacher layers comprising the initial set of teacher layers and a last teacher layer that is not part of the initial set of teacher layers;
generating a distillation loss from the last student layer, the last teacher layer, a student prediction generated by the student model, and a teacher prediction generated by the teacher model;
generating a task loss from the student prediction; and
training the student model with a training loss generated from combining the task loss and the distillation loss.

2. The method of claim 1, further comprising:
generating a hidden parameter loss from a set of teacher parameters from the last teacher layer and a set of student parameters from the last student layer.

3. The method of claim 1, further comprising:
generating a hidden state loss from a hidden teacher state from the last teacher layer and a hidden student state from the last student layer.

4. The method of claim 1, further comprising:
generating a prediction loss from the teacher prediction and the student prediction.

5. The method of claim 1, further comprising:
generating the distillation loss using a processor to combine a hidden parameter loss, a hidden state loss, and a prediction loss.

6. The method of claim 1, further comprising:
generating the task loss using a processor to combine the student prediction with an expected value.

7. The method of claim 1, further comprising:
generating the training loss using a processor to perform a weighted combination of the task loss with the distillation loss.

8. The method of claim 1, further comprising:
training the student model using a processor to backpropagate the training loss to one or more student layers of the student model.

9. The method of claim 1, further comprising:
initializing the set of student layers as a copy of the initial set of teacher layers.

10. The method of claim 1, further comprising:
deploying the student model;
receiving an input for the student model;
processing the input to the student model to generate an output; and
performing an action responsive to the output.

11. A system comprising:
at least one processor; and
an application executing on the at least one processor to perform operations comprising:
initializing a set of student layers of a student model from an initial set of teacher layers of a teacher model,
wherein the student model comprises a last student layer as one of the set of student layers, and
wherein the teacher model comprises a set of teacher layers comprising the initial set of teacher layers and a last teacher layer that is not part of the initial set of teacher layers,
generating a distillation loss from the last student layer, the last teacher layer, a student prediction generated by the student model, and a teacher prediction generated by the teacher model,
generating a task loss from the student prediction, and
training the student model with a training loss generated from combining the task loss and the distillation loss.

12. The system of claim 11, wherein the operations further comprise:
generating a hidden parameter loss from a set of teacher parameters from the last teacher layer and a set of student parameters from the last student layer.

13. The system of claim 11, wherein the operations further comprise:
generating a hidden state loss from a hidden teacher state from the last teacher layer and a hidden student state from the last student layer.

14. The system of claim 11, wherein the operations further comprise:
generating a prediction loss from the teacher prediction and the student prediction.

15. The system of claim 11, wherein the operations further comprise:
generating the distillation loss using a processor to combine a hidden parameter loss, a hidden state loss, and a prediction loss.

16. The system of claim 11, wherein the operations further comprise:
generating the task loss using a processor to combine the student prediction with an expected value.

17. The system of claim 11, wherein the operations further comprise:
generating the training loss using a processor to perform a weighted combination of the task loss with the distillation loss.

18. The system of claim 11, wherein the operations further comprise:
training the student model using a processor to backpropagate the training loss to one or more student layers of the student model.

19. The system of claim 11, wherein the operations further comprise:
initializing the set of student layers as a copy of the initial set of teacher layers.

20. A non-transitory computer readable medium comprising instructions that when executed perform operations comprising:
initializing a set of student layers of a student model from an initial set of teacher layers of a teacher model,
wherein the student model comprises a last student layer as one of the set of student layers, and
wherein the teacher model comprises a set of teacher layers comprising the initial set of teacher layers and a last teacher layer that is not part of the initial set of teacher layers;
generating a distillation loss from the last student layer, the last teacher layer, a student prediction generated by the student model, and a teacher prediction generated by the teacher model;
generating a task loss from the student prediction;
training the student model with a training loss generated from combining the task loss and the distillation loss.
